(19) United States
(12) Patent Application Publication
(10) Pub. No.: US 2017/0248491 A1
(43) Pub. Date: Aug. 31, 2017

(54) DIAGNOSTIC FOR RESOLUTION-ENHANCED TEMPORAL MEASUREMENT OF SHORT OPTICAL PULSES

(71) Applicant: Christophe Dorrer, Rochester, NY (US)

(72) Inventor: Christophe Dorrer, Rochester, NY (US)

(21) Appl. No.: 15/054,874

(22) Filed: Feb. 26, 2016

(51) Int. Cl. G01M 11/00

(52) U.S. Cl. CPC G01M 11/33

(57) ABSTRACT

The disclosure relates to the measurement of temporal characteristics of optical pulses. Embodiments may be used for single-shot characterization of picosecond optical pulses. The optical pulse may be split into a plurality of ancillary pulses. Amounts of distortion may be added to the plurality of ancillary pulses. An instantaneous power of the plurality of ancillary pulses may be measured. Thereafter, an experimental trace with the measured instantaneous powers may be constructed and the experimental trace may be outputted. The experimental trace may be processed to calculate temporal characteristics of the input optical pulse. A fiber assembly may be used to split the pulse into the plurality of ancillary pulses. The fiber assembly may include one or more splitters. The one or more splitters may direct the ancillary pulses along different optical paths having different lengths to temporally separate the ancillary pulses and to add amounts of distortion.

### STATEMENT REGARDING FEDERAL FUNDING

This invention was made with government support under contract # DE-NA0001944 awarded by Department of Energy. The U.S. government has certain rights in the invention.

### BACKGROUND

Described below are systems and methods for characterization of optical pulses. Particular embodiments relate to temporal characterization of femtosecond and picosecond optical pulses.

Temporal characterization is an important process when building, operating, and using sources of short optical pulses. High-energy laser systems require temporal diagnostics for safe operation and interpretation of experiments. While techniques are available to characterize short optical pulses, further improvements may be desired for enhanced performance and versatility.

### SUMMARY

The disclosure generally applies to the measurement of temporal characteristics of optical pulses. In general, a detection system may include a photodetector and an oscilloscope, and the frequency bandwidth of these components may limit the temporal resolution of the measurement. When the pulse is shorter than the impulse response of the measurement system, the measured pulse shape is a blurred representation of the actual (physical) pulse shape, and the measured characteristics do not depend significantly on the physical characteristics of the pulse. In these conditions, there is only sparse information on the pulse characteristics that can be recovered from the measured data, particularly in practical conditions when the relative measurement noise is significant and the sampling rate is low relative to the duration of the pulse under test. The present disclosure circumvents these problems by measuring a plurality of ancillary optical pulses derived from the pulse under test by adding distortions. The experimental trace is constructed with the instantaneous power of these optical pulses (i.e., what is commonly referred to as the pulse shape) measured as a function of time with the photodetection system. Algorithms may be used to retrieve high-resolution temporal information about the pulse under test, e.g., remove the temporal blur introduced by the bandwidth-limited photodetection system. Algorithms may also return a more complete representation of the optical pulse, e.g., a representation of the temporal phase of the pulse as a function of time. Square-law photodetectors are only sensitive to the power of the electric field and do not directly allow for a measurement of the phase of the electric field. Some embodiments of the disclosure and algorithms can retrieve information on the electric field of the optical pulse under test that is not readily available even in the absence of bandwidth limitation from the photodetection system. Embodiments of the disclosure may use chromatic dispersion in an all-fiber assembly having one or more splitters and delay fibers to generate ancillary pulses. Such embodiments may be used for single-shot temporal characterization of femtosecond and picosecond optical pulses when used in conjunction with a real-time oscilloscope.

Accordingly, in some embodiments of the present disclosure, a method for temporal characterization of an optical pulse under test is provided. The method may include splitting the optical pulse under test into a plurality of ancillary pulses. Different distortions may be added to the plurality of ancillary pulses. In some embodiments, a functional form precisely describing the distortions may be available, while the distortions might only be known approximately in some other embodiments. An instantaneous power of each of the plurality of ancillary pulses may be measured and an experimental trace may be constructed with the measured instantaneous powers of each of the plurality of ancillary pulses thereafter. The experimental trace may then be outputted to a user (e.g., visual output from a computer display, printed to a report, or the like). Processing algorithms may be applied to the experimental trace to reconstruct the temporal pulse shape or temporal phase of the pulse under test. The reconstructed quantities may then be outputted to a user.

Optionally, splitting the optical pulse may be performed by coupling the optical pulse to a fiber assembly comprising at least one splitter to produce the plurality of ancillary pulses. The at least one splitter may be a series of splitters. The series of splitters may be at least five splitters, in certain embodiments. Optionally, the splitters comprise 2×2 splitters (i.e., two inputs and two outputs).

The distortion may be added to the plurality of ancillary pulses by adding chromatic dispersion to the ancillary pulses. In some embodiments, the distortion may be added to the plurality of ancillary pulses by delivering each of the plurality of ancillary pulses through different lengths of fiber. In some other embodiments, the distortion may be added to the plurality of ancillary pulses by propagation in an integrated waveguide structure, e.g., ring resonators, by propagation in a chirped fiber Bragg grating or volume Bragg grating, by reflection on a chirped mirror, by free-space propagation in optical assemblies comprising gratings or prisms, or a combination of these effects.

In some embodiments, the optical pulse is split into at least two ancillary pulses. In further embodiments the optical pulse is split into at least four or even sixteen ancillary pulses and in still further embodiments the optical pulse may be split into sixty-four ancillary pulses. In some embodiments, the ancillary pulses may be temporally separated by at least 20 ns.

In further embodiments, a method for temporal characterization of an optical pulse under test may include splitting the optical pulse into a plurality of pulses comprising at least a first ancillary pulse and a second ancillary pulse. The first and second ancillary pulses may be temporally delayed and different distortions may be induced on each pulse. An instantaneous power of the first and second ancillary pulse may then be measured. An optical spectrum of the pulse under test may be measured. The measured instantaneous powers and the measured optical spectrum may be used to determine the shape of the optical pulse under test. Thereafter, the determined pulse shape may be outputted.

Optionally, inducing a distortion on the ancillary pulses is achieved by delivering the first ancillary pulse through a first length of fiber along a first optical path and the second ancillary pulse through a second length of fiber along a second optical path. The second length of fiber may be greater than the first length of fiber.

Embodiments of the disclosure may also provide a system for temporal characterization of an optical pulse. The system may include a fiber assembly having a first optical pulse input for receiving an optical pulse. The fiber assembly may be configured to split the received optical pulse into a plurality of ancillary pulses. The fiber assembly may also be configured to add amounts of distortion to the plurality of ancillary pulses. A photodetector may be coupled with the fiber assembly. An oscilloscope may be coupled with the photodetector and configured to measure an instantaneous power of the plurality of ancillary pulses. In some embodiments the oscilloscope is a real-time oscilloscope. In some other embodiments, the oscilloscope is a sampling oscilloscope.

In many embodiments, the system may characterize optical pulses having a duration of the order or shorter than the sampling rate of the oscilloscope and the photodetection impulse response. In certain embodiments, the system may be configured to provide single-shot analysis of an optical pulse. In some experiments, the system may characterize optical pulses with duration of the order of 1 picosecond even when the impulse response of the photodetector and the oscilloscope may be as long as 20 picoseconds.

The fiber assembly may have a series of splitters including a first splitter and a second splitter. The first splitter may be configured to split the received optical pulse into a first portion along a first optical path having a first output and a second portion along a second optical path having a second output. The second optical path may have a length greater than the first optical path. The second splitter may be configured to recombine the two optical paths, then split the received pulses along a first optical path and a second optical path of the second splitter. The first output of the first optical path of the first splitter and the second output of the second optical path of the first splitter may be connected to the two inputs of the second splitter. Optionally, a third splitter is used, with the two outputs of the second splitter connected to the two inputs of the third splitter via two optical paths. The optical paths between the second and third splitter may have different length, and their lengths may differ from the length of the optical paths between the first and second splitter.

The second optical path of the first splitter may be sufficiently long to induce measurable distortions on the optical pulse via chromatic dispersion. The system may have an impulse response that is short enough to distinguish differences between the measured pulse shapes of the ancillary pulses. Optionally, the fiber assembly may further include a second optical pulse input for receiving a second optical pulse under test.

In further embodiments of the present disclosure, a system for temporal characterization of optical pulses may be provided. The system may include a fiber assembly comprising a first optical pulse input for receiving an optical pulse and a first splitter. The first splitter may be configured to split the received optical pulse into a first ancillary pulse along a first optical path having a first output and a second ancillary pulse along a second optical path having a second output. The second optical path may have a length greater than the first optical path. A photodetector may be coupled with the fiber assembly and an oscilloscope may be coupled with the photodetector.

In some embodiments, the fiber assembly comprises a series of splitters including the first splitter and a second splitter. The second splitter may be configured to split received pulses along a first optical path and a second optical path of the second splitter. The first output of the first optical path of the first splitter and the second output of the second optical path of the first splitter may be coupled with an input of the second splitter.

In some embodiments, a system for temporal characterization of optical pulses may be provided. The system may include a fiber assembly comprising a series of splitters configured to split an optical pulse into a number (N) of temporally separated pulses where each pulse of the number of pulses has a dispersion of D₀+kδD relative to the optical pulse, D₀ being the dispersion resulting from fiber of the fiber assembly that is common to all pulses, δD being the relative dispersion between two consecutive pulses, and k being a pulse number, 1 to N. A photodetector may be coupled with the fiber assembly and configured to receive the number of pulses and an oscilloscope may be coupled with the photodetector.

In some embodiments, N is at least 4. Optionally, N may be at least 8, 16 or 32. The pulses may have a relative separation of 20 ns or more. The series of splitters may comprise two splitters, or more (e.g., five, six, seven splitters, etc.).

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

The invention will be better understood upon reading the following description and examining the figures which accompany it. These figures are provided by way of illustration only and are in no way limiting on the invention.

### BRIEF DESCRIPTION OF THE DRAWINGS

Further details, aspects and embodiments of the invention will be described by way of example only and with reference to the drawings. In the drawings, like reference numbers are used to identify like or functionally similar elements. Elements in the figures are illustrated for simplicity and clarity and have not necessarily been drawn to scale.

FIG. 1 shows an exemplary method according to some embodiments of the disclosure.

FIG. 2 shows an exemplary system diagram according to some embodiments of the disclosure;

FIG. 3 shows a train of 64 output pulses spanning ˜1.2 μs for an input pulse close to the Fourier-transform limit (the amplitudes decrease because of the dispersion-induced stretching);

FIG. 4 shows an 18-ps photodetection impulse response sampled at 120 GSamples/s, i.e., 8.25 ps/sample (blue line and markers);

FIG. 5 shows an experimental trace comprising the 64 measured instantaneous powers produced by the exemplary system shown in FIG. 2;

FIG. 6 shows measured pulse duration (markers) and modeled pulse duration (dashed line) versus stretcher dispersion;

FIG. 7 shows a close-up over duration range below the photodetection impulse response (the statistics correspond to ten acquisitions);

FIG. 8 shows pulse shape directly measured by the photodetection system for the four settings plotted in FIG. 7;

FIG. 9 shows pulse shape reconstructed by phase-diversified photodetection for the same four settings (five measured pulse shapes per setting);

FIG. 10 shows pulse autocorrelation measured at the best-compression setting with a single-shot autocorrelator and calculated using the pulse retrieved with phase-diversified photodetection;

FIG. 11 shows on-shot pulse shapes measured with phase-diversified photodetection and with a streak camera for on-shot pulse duration of 5 ps; and

FIG. 12 shows on-shot pulse shapes measured with phase-diversified photodetection and with a streak camera for on-shot pulse duration of 12 ps.

### DETAILED DESCRIPTION

The subject matter of embodiments of the present invention is described here with specificity, but the claimed subject matter may be embodied in other ways, may include different elements or steps, and may be used in conjunction with other existing or future technologies.

Temporal characterization is an important process when building, operating, and using sources of short optical pulses. Pulses with duration of the order of 100 ps or shorter are routinely used to transmit information in optical telecommunication systems and perform laser-matter interaction experiments. There are many techniques to temporally characterize optical pulses, but the single-shot characterization of picosecond pulses remains difficult, particularly in non-ideal conditions (e.g., poor beam profile, wavefront distortions, and pointing instabilities). Direct single-shot measurements with photodiodes and oscilloscopes may be able to offer a sub-20-ps impulse response, but the relatively low signal-to-noise ratio and sampling rate may not allow for deconvolution to characterize shorter pulses.

In some optical pulse characterization techniques, an optical pulse may be split into two optical pulses. One of the optical pulses may be propagated in an optical fiber that adds chromatic dispersion. The instantaneous power of the two pulses may then be measured as a function of time. The temporal characteristics of the pulse under test may be recovered by numerical processing, for example using the temporal transport-of-intensity equation or a modified Gerchberg-Saxton algorithm. This approach may be limited in its applicability because it requires sampling of the measured instantaneous powers at a rate relatively high compared to the duration of the two powers being measured. For pulses with duration of the order of 20 ps and shorter, this is only achievable using sampling oscilloscopes that require repetitive signals. This approach therefore may not readily be applicable for the single-shot characterization of isolated events that are common in practical situations such as telecommunication systems and laser systems. Embodiments of the disclosure presented herein may circumvent these limitations by using a plurality of optical pulses and can be applied identically with sampling oscilloscopes (for a repetitive signal) and with real-time oscilloscopes (for non-repetitive signals). The real-time oscilloscopes may have lower sampling rates than sampling oscilloscopes but can capture the instantaneous powers of all the pulses generated by the fiber assembly in a single acquisition.

In other characterization methods, an optical pulse under test may be split in a plurality of optical pulses for the purpose of increasing the measurement signal-to-noise ratio. The instantaneous power of these pulses may be measured with a photodiode and oscilloscope, and the instantaneous power of the pulse under test may be reconstructed by averaging the measured instantaneous powers. The purpose of the fiber assembly in this method is to create a plurality of pulses identical to the pulse under test, i.e., pulses with instantaneous powers that are scaled versions of the input instantaneous power. Distortions of the generated pulses are therefore highly detrimental to the operation of the diagnostic. This approach can only operate when the photodetection system is capable of measuring the input pulse with sufficient resolution (e.g., has a bandwidth and sampling rate that are high enough). Hence, this technique is limited to the characterization of narrowband optical signals with relatively long duration, typically 100 ps and longer.

Embodiments of the disclosure may provide single-shot characterization of optical pulses with picosecond precision. FIG. 1 shows an exemplary method 100 for characterizing an input optical pulse according to some embodiments of the disclosure. At 102, the input optical pulse may be split into a plurality of ancillary pulses. At 104, amounts of distortion may be added to the ancillary pulses. At 106, the instantaneous power of the plurality of ancillary pulses may be measured. At 108, an experimental trace may be constructed with the measured instantaneous powers. At 110, the experimental trace may be outputted in a manner perceptible to a user, such as output to a computer display, printing in a report, or the like. In some embodiments, a processing algorithm is applied to the experimental trace so that temporal characteristics of the input optical pulse are determined 112. The temporal characteristics of the input optical pulse may then be outputted 114.

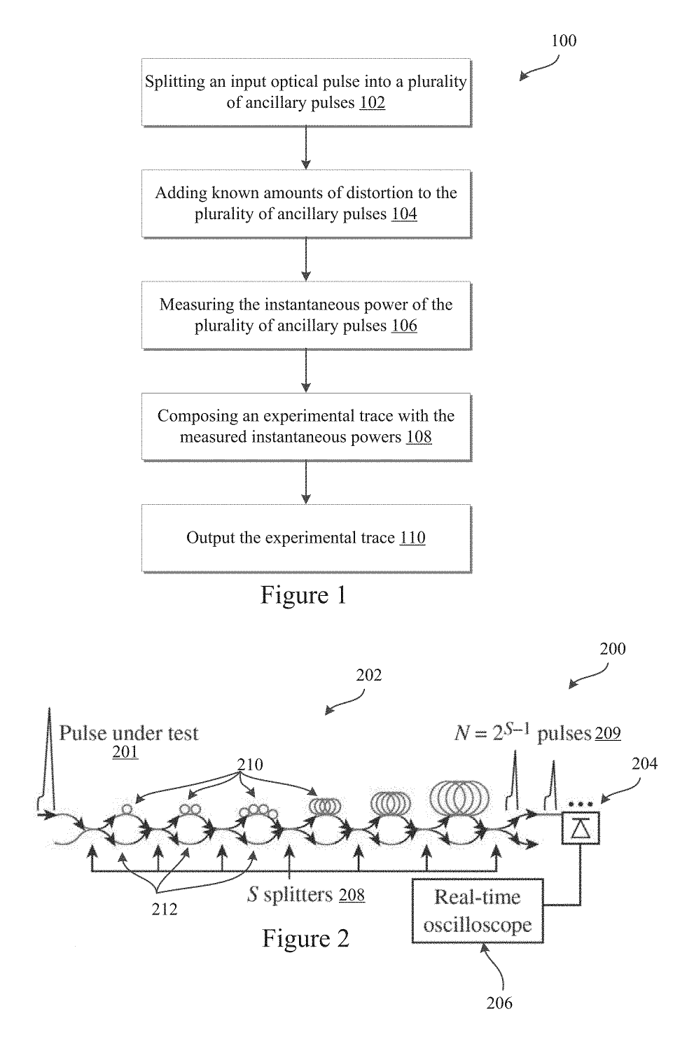

FIG. 2 shows an exemplary system 200 that may perform the method 100 according to some embodiments of the disclosure. The system 200 includes a fiber assembly 202 configured to receive the input pulse under test 201. One output of the fiber assembly 202 is coupled with a photodetector 204. The photodetector 204 is coupled with an oscilloscope 206.

The exemplary system 200 may split an input optical pulse into 64 pulses that are temporally delayed and experience amounts of chromatic dispersion in optical fibers. The instantaneous power of the 64 pulses and the input optical spectrum measured in a single shot may be processed to determine the input pulse shape without the effect of the impulse response. The input optical spectrum may be determined by a grating-based spectrometer. Operation of exemplary system 200 may be analogous to phase-diversity wavefront sensing, where the far-field distribution of an optical beam is measured for various amounts of defocus to determine the near-field characteristics. The all-fiber setup and linear photodetection of system 200 may allow for extremely high sensitivity (˜30 pJ in the input fiber) with simple and reliable operation in the beam near field. This diagnostic may simultaneously characterize two distinct optical pulses coupled to the two inputs of fiber assembly 202.

The pulse under test 201 may be coupled into a fiber assembly 202 having S2×2 splitters 208. The splitters 208 may be configured to split 102 the input optical pulse into a plurality of ancillary pulses 209. In the exemplary system 200, the fiber assembly 202 includes seven splitters 208. Each splitter 208 may be configured to divide received pulses along a first optical path and a second optical path. One path may be a long/delay path 210 having a longer fiber length and the other may be a short path 212 having a shorter fiber length. Accordingly, in some embodiments of the disclosure, the splitters 208 may be configured to temporally delay ancillary pulses of the inputted optical pulse relative to one another. The two outputs of one splitter 208 may be connected to the two inputs of the next splitter 208 with different fiber lengths in the two optical paths. The illustrated setup generates N=64 pulses with a relative separation of 20 ns using seven splitters 208 and a relative fiber length equal to 2^{j-1}×4 m between the long and short paths connecting splitters j and j+1 (j=1 to 6 for system 200).

The optical paths between each pair of splitters 208 may be configured to add amounts of chromatic distortion to the ancillary pulses 104. The longer optical path of a splitter may be sufficiently long to induce measurable distortions on the optical pulse via chromatic dispersion. A short optical pulse has a broad optical spectrum, i.e., it is composed of a large number or a continuum of optical wavelengths spanning a range Δλ. This is of the order of λ²/(cΔT), where c is the speed of light in vacuum, λ is the central wavelength of the pulse, and ΔT is the Fourier-transform-limited duration of the optical pulse, i.e., the shortest pulse duration that can be sustained for a given spectrum. Propagation of an optical pulse with bandwidth Δλ in a medium with chromatic dispersion δD (expressed in unit of delay per wavelength, e.g., ps/nm) leads to changes in the group delay of the wavelengths in the spectrum of the optical pulse of the order of δDΔλ. Chromatic dispersion leads to measurable distortions on the optical pulse when the range of induced group delays, δDΔλ, is a significant fraction ρ of the duration ΔT. This leads to the order-of-magnitude relation δDΔλ²/(cΔλ²) for the relative dispersion δD that can be used between successive output pulses. For pulses with Δλ=8 nm at the central wavelength λ=1053 nm, using ρ=20%, the estimated dispersion is 0.012 ps/nm. This dispersion can be obtained by propagation in approximately 3 meters of optical fiber. Fiber assemblies that lead to more than two output pulses can be configured so that the relative dispersion between successive output pulses is approximately equal to the value calculated above. A large range of dispersion values will lead to an operational diagnostic to characterize an optical pulse, and a given diagnostic can therefore characterize a variety of different optical pulses.

Alternative implementations of the fiber assembly 202 may be used. The fiber splitters could have a larger number of input or output ports (e.g., 1×4 splitters or the like). Optical fibers with different properties, e.g., linear chromatic dispersion, could be used between different pairs of splitters. Integrated waveguide structures for splitting an optical pulse into multiple ancillary pulses and inducing chromatic dispersion could be used. The splitting and recombining steps could be performed by beam splitters in a free-space optical setup. Optical setups containing dispersive optical glass, gratings, prisms, grisms, and mirrors could advantageously be used in some embodiments of this invention. For example, the optical pulse may be split with free-space beam splitters in some embodiments. Optionally, distortion may be added using an assembly with diffraction gratings. In certain embodiments, the distortion may be added by propagating the ancillary pulses into chirped Bragg gratings, chirped fiber Bragg gratings, or chirped volume Bragg gratings.

The sixty four output pulses accumulate dispersion proportional to the fiber length in which they propagate, i.e., pulse k (k=1 to N) has dispersion D₀+kδD (D₀=dispersion resulting from fiber common to all pulses, δD=relative dispersion between two consecutive pulses). Chromatic dispersion induced by propagation in a dispersive medium is proportional to the medium length and its linear dispersion per unit length, which itself depends on a variety of factors including chemical composition, e.g., type of glass, and geometry, e.g., fiber core size. The fiber dispersion (˜−40 ps/nm/km at 1053 nm) leads to 64 pulses with significant pulse-shape changes, even after convolution by the 18-ps impulse response of the phototdetection and sampling at 120 GSamples/s. Optionally, two independent optical pulses may be measured using the two inputs of the fiber assembly 202.

A photodetector 204 may be coupled with the output of the fiber assembly 202 to receive each of the ancillary pulses. In some embodiments, a photodetection system with an 18-ps impulse response may be used. In an experimental setup, a Discovery Semiconductors DSC10 photodiode was used. An oscilloscope 206 may be coupled with the photodetector 204 to measure the instantaneous power of each of the ancillary pulses. In the experimental setup a Lecroy Wavemaster 45-GHz Oscilloscope was used. Thereafter, an experimental trace may be constructed using the measured instantaneous powers of the ancillary pulses 108. Various processing approaches can be used to recover temporal information about the input pulse from the measured experimental trace. One processing approach includes minimizing or otherwise limiting the difference between the measured experimental trace and an experimental trace calculated with known physical quantities and parameters of the input pulse to be determined. The known physical quantities can include the optical spectrum of the input pulse, the parameters of the assembly used to generate the ancillary pulses and induce distortions, and the impulse response of the photodetection system. The input-pulse parameters can, for example, be a description of its spectral phase in the form of a Taylor polynomial expansion around the central frequency of the pulse or a sum of sinusoidal modulations. An experimental trace can be calculated for a given set of parameters by simulating the generation of the ancillary pulses and their photodetection in the diagnostic. An error metric, e.g., the root-mean-square difference between the calculated trace and the measured trace, then quantifies the consistency between these two traces for that particular set of pulse parameters. An optimal set of parameters that minimizes the difference between the calculated and measured trace can be determined using well-known algorithms, e.g., gradient-based optimization or deterministic scan of the parameters over relevant ranges. Once the pulse's spectral phase is determined from the optimal set of parameters, the temporal pulse shape is determined by Fourier transforming the spectral representation of the pulse, i.e., the spectral electric field calculated from the measured optical spectrum and determined spectral phase. The determined spectral phase parameters, the spectral phase, and the input-pulse shape can then be outputted.

Depending on the application, each of the ancillary pulses may not be necessary for temporal characterization of the optical pulse. For example, with greater numbers of ancillary pulses spanning the same total range of distortion, the differences between consecutive pulses will be reduced. Accordingly, in some implementations of the disclosure, only a portion of the ancillary pulses are processed in order to characterize the optical pulse (e.g., every other ancillary pulse may be selected to characterize the optical pulse).

Experimental Results:

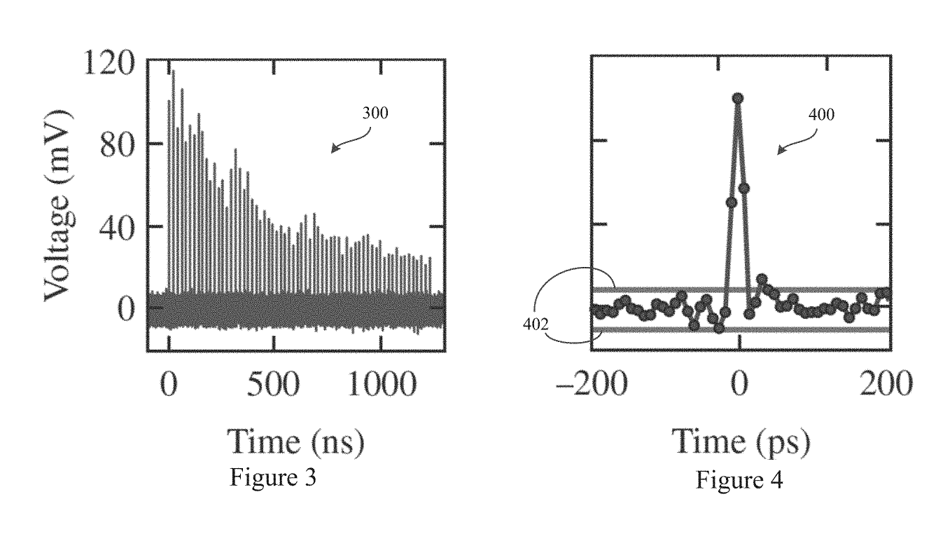

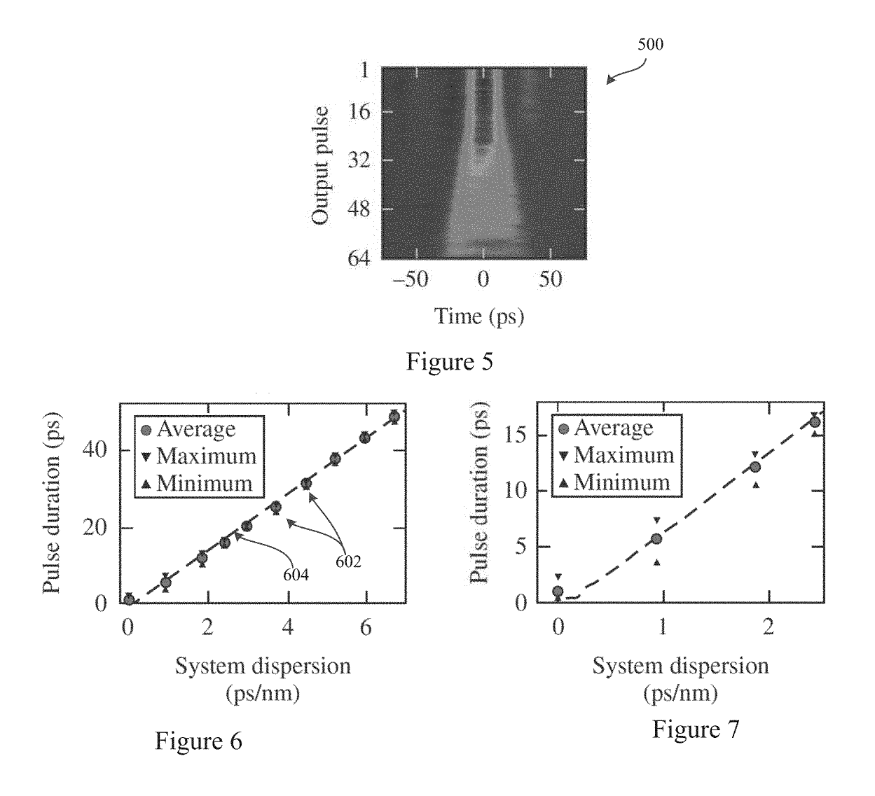

FIG. 3 shows a train 300 of 64 output pulses spanning ˜1.2 μs for an input pulse close to the Fourier-transform limit (the amplitudes decrease because of the dispersion-induced stretching). FIG. 4 shows an 18-ps photodetection impulse response 400 sampled at 120 GSamples/s, i.e., 8.25 ps/sample (line and markers) and peak-to-valley noise 402. FIG. 5 shows an experimental trace 500 comprising the 64 measured instantaneous powers produced by the exemplary system 200 shown in FIG. 2.

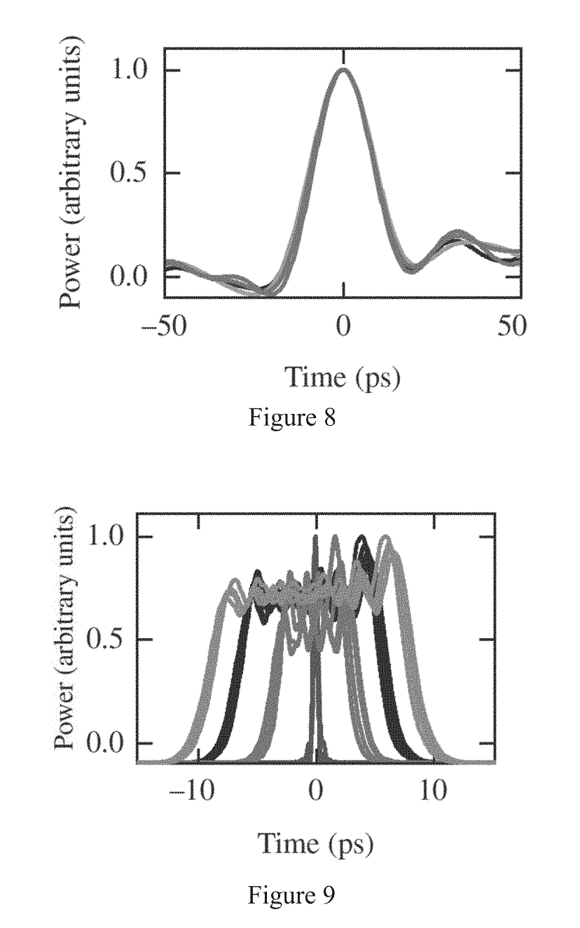

High-energy systems require temporal diagnostics for safe operation and interpretation of experiments. Some systems have a low duty cycle (˜1 shot/h) and typically far from ideal spatial properties. OMEGA EP delivers amplified pulses with duration from sub-1 ps to 100 ps by adjustment of its stretchers. Front-end pulses propagating in the laser system have been characterized with phase-diversified photodetection and the measured pulse duration is in excellent agreement with the modeled pulse duration when the stretcher is set to unbalance the overall system. FIG. 6 shows measured pulse duration (markers 602) and modeled pulse duration (dashed line 604) versus stretcher dispersion. FIG. 7 shows a close-up over duration range below the photodetection impulse response (the statistics correspond to ten acquisitions). FIG. 8 shows pulse shapes directly measured by the photodetection system for the four settings plotted in FIG. 7. As can be seen, the pulse shapes directly photodetected for each of the four stretcher settings of FIG. 7 are nearly indistinguishable. This shows that direct photodetection would not allow for precise and accurate characterization of the pulse shape over a large range of pulse durations that are of interest. FIG. 9 demonstrates that the same photodetection system, when used in the context of this invention, yields pulse shapes in agreement with expectations and high-enough precision to allow for stretcher adjustments for safe operation considering the on-shot energy and damage threshold of the optical components. The pulse shapes shown in FIG. 9 correspond to pulse shapes reconstructed by the diagnostic for the four stretcher settings of FIG. 7. These pulse shapes can easily be distinguished from one another and the different pulse durations are clearly visible. The pulse shape was measured five times at each stretcher settings, and the determined pulse shape was consistently and precisely retrieved.

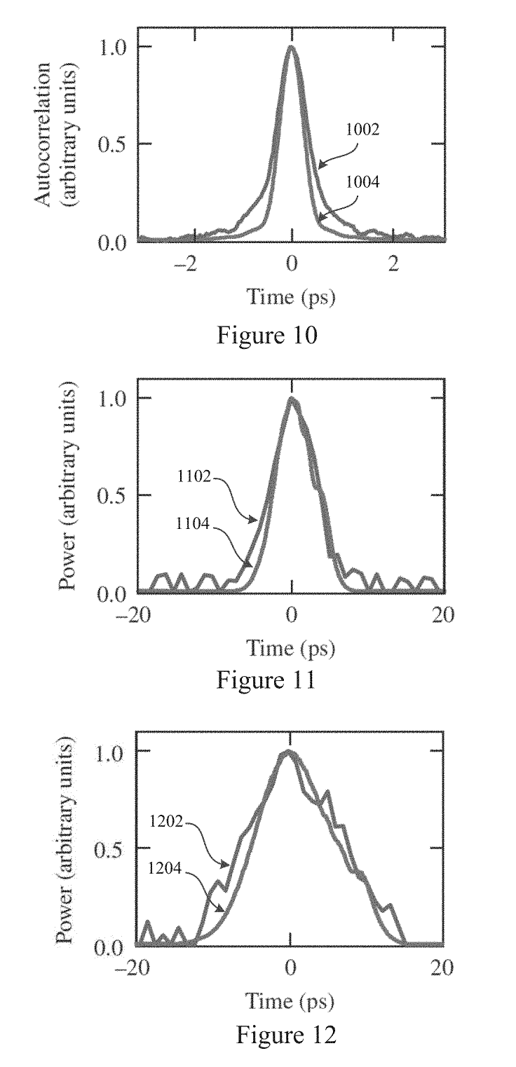

An independent measurement with a single-shot autocorrelator confirms the ability to identify the best-compression stretcher setting (zero second-order dispersion) with subpicosecond pulse duration. FIG. 10 shows pulse autocorrelation measured at the best-compression setting with a single shot autocorrelator 1002 and calculated using the pulse retrieved with phase-diversified photodetection 1004. Pulse shapes measured on amplified shots (50 J) were compared with pulse shapes directly measured with a streak camera when the system was set to generate either a 5-ps or a 12-ps pulse. FIG. 11 shows on-shot pulse shapes measured with phase-diversified photodetection 1104 and with a streak camera 1102 for on-shot pulse durations of 5 ps. FIG. 12 shows on-shot pulse shapes measured with phase-diversified photodetection 1204 and with a streak camera 1202 for on-shot pulse duration of 12 ps.

One or more computing devices may be adapted to provide desired functionality by accessing software instructions rendered in a computer-readable form. When software is used, any suitable programming, scripting, or other type of language or combinations of languages may be used to implement the teachings contained herein. However, software need not be used exclusively, or at all. For example, some embodiments of the methods and systems set forth herein may also be implemented by hard-wired logic or other circuitry, including but not limited to application-specific circuits. Combinations of computer-executed software and hard-wired logic or other circuitry may be suitable as well.

Embodiments of the methods disclosed herein may be executed by one or more suitable computing devices. Such system(s) may comprise one or more computing devices adapted to perform one or more embodiments of the methods disclosed herein. As noted above, such devices may access one or more computer -readable media that embody computer-readable instructions which, when executed by at least one computer, cause the at least one computer to implement one or more embodiments of the methods of the present subject matter. Additionally or alternatively, the computing device(s) may comprise circuitry that renders the device(s) operative to implement one or more of the methods of the present subject matter.

Any suitable computer-readable medium or media may be used to implement or practice the presently-disclosed subject matter, including but not limited to, diskettes, drives, and other magnetic-based storage media, optical storage media, including disks (e.g., CD-ROMS, DVD-ROMS, variants thereof, etc.), flash, RAM, ROM, and other memory devices, and the like.

The subject matter of embodiments of the present invention is described here with specificity, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications may be made without departing from the scope of the claims below.

References List, each of which are incorporated herein in their entirety:

I. A. Walmsley and C. Dorrer, “Characterization of ultrashort electromagnetic pulses,” Adv. Opt. Photon. 1, 308-437 (2009).

J. H. Kelly et al., “OMEGA EP: High Energy petawatt capability for the Omega Laser Facility,” J. Phys. IV France 133, 75-80 (2006).

What is claimed is:

1. A method for temporal characterization of an optical pulse, the method comprising:
splitting the optical pulse into at least four ancillary pulses;
adding distortion to at least some of the at least four ancillary pulses;
measuring an instantaneous power of the at least four ancillary pulses;
constructing an experimental trace with the measured instantaneous powers; and
outputting the experimental trace.

2. The method of claim 1, further comprising processing the experimental trace to temporally characterize the optical pulse and outputting the optical pulse characterization.

3. The method of claim 1, wherein the method is used for single-shot analysis of the optical pulse.

4. The method of claim 1, wherein the ancillary pulses experience known amounts of chromatic dispersion.

5. The method of claim 1, wherein a temporal shape of the optical pulse is determined without an effect of an impulse response.

6. The method of claim 1, further comprising measuring a spectrum of the optical pulse.

7. The method of claim 1, further comprising determining a spectral phase of the optical pulse.

8. The method of claim 1, wherein splitting the optical pulse comprises coupling the optical pulse to a fiber assembly comprising at least one splitter to produce the plurality of ancillary pulses.

9. The method of claim 8, wherein the at least one splitter comprises a series of splitters.

10. The method of claim 8, wherein the splitters comprise 2×2 splitters.

11. The method of claim 1, wherein the optical pulse is split with free-space beam splitters.

12. The method of claim 1, wherein adding the distortion to the plurality of ancillary pulses comprises delivering each of the plurality of ancillary pulses through different lengths of fiber.

13. The method of claim 1, wherein adding the distortion to the plurality of ancillary pulses comprises propagating the ancillary pulses into an assembly that includes diffraction gratings.

14. The method of claim 1, wherein adding the distortion to the plurality of ancillary pulses comprises propagating the ancillary pulses into chirped Bragg gratings.

15. The method of claim 1, wherein the instantaneous power is measured with a photodiode.

16. The method of claim 1, wherein the instantaneous power is measured with a real-time oscilloscope.

17. A method for temporal characterization of an optical pulse, the method comprising:
splitting the optical pulse into a plurality of portions comprising at least a first portion and a second portion;
temporally delaying the second portion of the optical pulse relative to the first portion of the optical pulse;
adding distortion to the plurality of portions;
measuring an instantaneous power of the first portion and the second portion using an oscilloscope;
measuring an input optical spectrum;
processing the measured instantaneous power and the measured input optical spectrum to determine a pulse shape of the optical pulse;
outputting the determined pulse shape of the optical pulse.

18. The method of claim 17, wherein the oscilloscope comprises a real-time oscilloscope.

19. The method of claim 17, wherein the first portion and the second portion experience known amounts of chromatic dispersion.

20. The method of claim 17, wherein the pulse shape is determined without an effect of an impulse response.

21. The method of claim 17, wherein splitting the optical pulse comprises coupling the optical pulse to a fiber assembly comprising at least one splitter.

22. The method of claim 21, wherein the at least one splitter comprises a series of splitters.

23. The method of claim 22, wherein the series of splitters comprises at least five splitters.

24. The method of claim 22, wherein the splitters comprise 2×2 splitters.

25. The method of claim 17, wherein temporally delaying the second portion of the optical pulse relative to the first portion comprises delivering the first portion through a first length of fiber along a first optical path and the second portion through a second length of fiber along a second optical path, the second length of fiber being greater than the first length of fiber.

26. The method of claim 17, wherein the optical pulse is split into at least four separate and spaced apart portions.

27. The method of claim 26, wherein the optical pulse is split into at least sixteen separate and spaced apart portions.

28. The method of claim 27, wherein the optical pulse is split into at least sixty-four separate and spaced apart portions.

29. The method of claim 17, wherein the second portion is temporally delayed at least 20 ns.

30. A system for temporal characterization of an optical pulse, the system comprising:
a fiber assembly having a first optical pulse input for receiving an optical pulse and configured to split the received optical pulse into a plurality of ancillary pulses, the fiber assembly further configured to add distortion to the plurality of ancillary pulses;
a photodetector coupled with the fiber assembly; and
an oscilloscope coupled with the photodetector and configured to measure an instantaneous power of the plurality of ancillary pulses.

31. The system of claim 30, wherein the fiber assembly comprises a series of splitters including a first splitter and a second splitter, the first splitter configured to split the received optical pulse into a first portion along a first optical path having a first output and a second portion along a second optical path having a second output, and wherein the second optical path has a length greater than the first optical path;
the second splitter configured to receive the first portion at a first input and the second portion at a second input.

32. The system of claim 30, wherein the optical paths between two successive splitters include an optical fiber with length that is at least twice the length of an optical fiber between the first and second splitter.

33. The system of claim 30, wherein the fiber assembly further comprises a second optical pulse input for receiving a second optical pulse.

34. A system for temporal characterization of an optical pulse, the system comprising:
a fiber assembly comprising a series of splitters configured to split an optical pulse into a number, N, of ancillary pulses, wherein N is greater than 1, and wherein each ancillary pulse has a dispersion of D₀+kδD relative to the optical pulse, D₀ being a dispersion resulting from fiber of the fiber assembly that is common to all ancillary pulses, δD being a relative dispersion between two consecutive ancillary pulses, and k being an ancillary pulse number, 1 to N.

35. The system of claim 34, further comprising:
a photodetector coupled with the fiber assembly and configured to receive the ancillary pulses; and
an oscilloscope coupled with the photodetector.

36. The system of claim 34, further comprising means to measure a spectrum of the optical pulse.
